(19) United States
(12) Patent Application Publication
(10) Pub. No.: US 2007/0084924 A1
(43) Pub. Date: Apr. 19, 2007

(54) Handheld scanner with a trigger guard

(76) Inventors: Hitoshi Watanabe, Saitama-shi (JP); Hironobu Watanabe, Koshigaya-shi (JP); Masaaki Abe, Saitama-shi (JP)

Correspondence Address: KAPLAN GILMAN GIBSON & DERNIER L.L.P., 900 ROUTE 9 NORTH, WOODBRIDGE, NJ, 07095, US

(21) Appl. No.: 11/252,637

(22) Filed: Oct. 18, 2005

(51) Int. Cl. G06K 7/08; G06K 7/00

(52) U.S. Cl. 235/451; 235/439

(57) ABSTRACT

A handheld scanner comprises a body including a scanner head portion and a grip portion, with a trigger for activating a scan operation provided on said grip portion. A trigger guard member is provided to form a loop together with the body surrounding the trigger, thereby preventing the trigger being accidentally or inadvertently activated.

### BACKGROUND OF THE INVENTION

The present invention relates to symbol reading devices, and more particularly, to a handheld scanner with a trigger guard.

As illustrated in FIG. 1, a conventional handheld barcode reader or scanner 10 comprises a grip portion 1 and a scanner head portion 2 forming an L-shaped body. A trigger 3 is provided on the grip portion 1 for activating a scan operation. However, sometimes the trigger 3 may be accidentally or inadvertently activated, e.g., when the scanner 10 accidentally drops or a user inadvertently presses on the trigger 3.

Therefore, there exists a need for a more reliable handheld scanner which can prevent the trigger from an accidental or inadvertent activation.

### SUMMARY OF THE INVENTION

To realize the above object, a handheld scanner of the present invention is provided which comprises a body, a trigger provided on the body for activating scan operations, and a trigger guard member having a first end and a second end. At least one of the two ends of the trigger guard member is connected to the body and extends from the body such that the trigger is located between the body and the guard member so as to prevent the trigger from accidental or inadvertent activation.

In a preferred embodiment, the body comprises a grip portion and a scanner head portion, and the trigger is provided on the grip portion. Preferably, the first end of the guard member is connected to the grip portion, and the second end of the guard member is connected to the scanner head portion, thus forming a protection loop surrounding the trigger. This also increases the mechanical strength of the scanner. In addition, when needed, a user can hold the scanner by the loop with only a single finger, thus freeing both hands to handle other things.

Preferably, the first end of the guard member is connected to the grip portion at a location close to the trigger, so that the user can easily locate the trigger during the scanning operation. Preferably, the second end of the guard member is connected to the head portion at a location close to a front end of the head portion. This may maximize the mechanical strength of the scanner to prevent damage if the scanner accidentally drops.

Preferably, an antenna for wireless communications is installed in the trigger guard member. Thus, the wireless communications will not be interfered with by the user's hand.

### BRIEF DESCRIPTION OF THE DRAWINGS

The above and other features and advantages will be clearer after reading the detailed description of the preferred embodiments of the present invention with reference to the accompanying drawings, in which:

FIG. 1 is a front view (normally called side view) schematically illustrating a handheld scanner in the prior art;

FIG. 2 is a front view (normally called side view) schematically illustrating an embodiment of a handheld scanner according to the present invention; and

FIG. 3 is a side view (normally called front view) of the embodiment in FIG. 2.

### DETAILED DESCRIPTION OF THE INVENTION

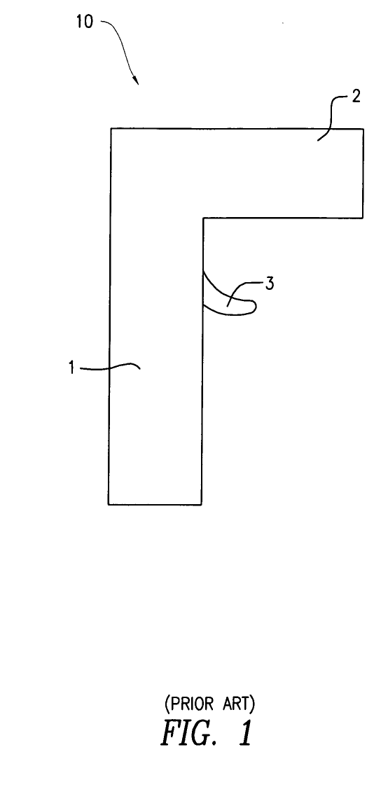

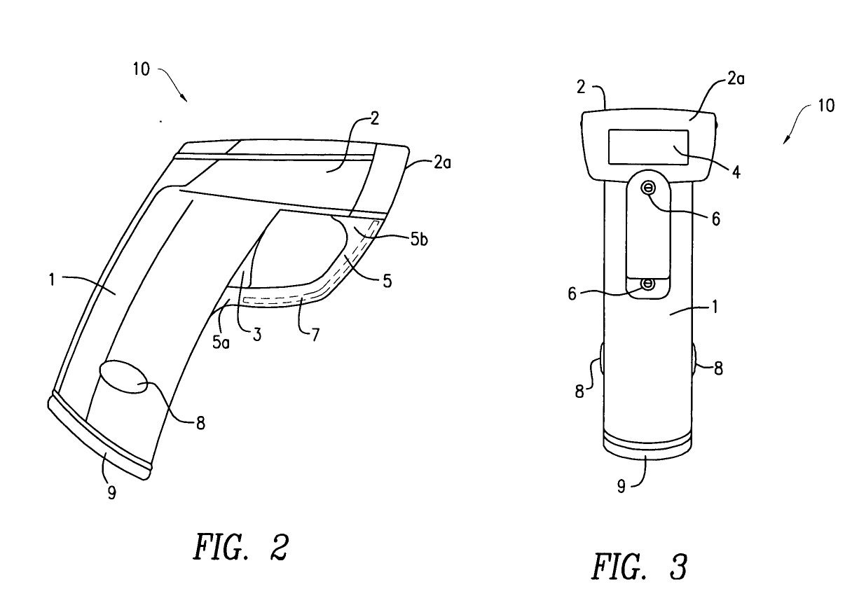

A preferred embodiment of a handheld scanner 10 according to the present invention is schematically illustrated in FIGS. 2-3. Similar to the prior art as illustrated in FIG. 1, the handheld scanner 10 in this embodiment comprises a handle or grip portion 1 and a scanner head portion 2 connected or molded as an integral body. In scanning operations, the scan light beam comes from a front end 2a of the head portion 2. Reflected light from the barcodes is also received by the scanner 10 through the front end 2a. A display, such as an LCD display opposite scan window 4, may be provided at the rear end opposite of the front end 2a for showing information decoded from the read barcodes. A trigger 3 is provided on the grip portion 1 for activating the scanning operations. A pair of release buttons 8 may be provided on the grip portion 1 for releasing a bottom cover 9, e.g., to install or replace batteries.

According to the teaching of the present invention, the scanner 10 further comprises a guard member 5 for preventing the trigger 3 from accidental or inadvertent activation as well as from physical damage, which may happen, e.g., when the scanner 10 accidentally drops to the ground or the trigger 3 accidentally hits something or is inadvertently pressed by a user.

In addition, when needed, the user may hold the scanner 10 by the loop with only a single finger so as to free both hands to handle things, e.g., to carry goods. Moreover, the guard member 3 also increases the mechanical strength of the scanner 10.

More specifically, the guard member 5 comprises a lower end 5a and an upper end 5b, which are detachably connected to the grip portion 1 and the head portion 2 respectively, forming with them a loop surrounding the trigger 3. Preferably, the guard member 5 is connected to the grip portion 1 and the head portion 2 by screws or bolts 6, or sliding or fixing mechanism with lock.

Preferably, the lower end 5a is connected to the grip portion 1 just below the trigger 3. Thus, the user can easily locate the trigger 3 simply by moving his or her finger down along the guard member 5. Preferably, a bottom of the trigger 3 and the lower end 5a of guard member 5 have matching contours.

Preferably, the upper end 5b is connected to the scanner head portion 2 at a location approximate to the front end 2a. This may maximize the mechanical strength of the scanner 10, especially that of the front end 2a where the scanning window 4 is located.

Alternative, the guard member 5 may be integrally molded with the body of the scanner 10.

If the scanner 10 is equipped with an antenna 7 for wireless communications, e.g., for RFID scanning operations, the antenna 7 is preferably installed in the guard member 5. This prevents the wireless communications signals being interfered with by the hand of the user. The antenna 7 may be internally wired or may work in an inductive manner.

Though the above has described the preferred embodiments of the present invention, it shall be understood that numerous adaptations, modifications and variations are possible to those skilled in the art without departing the gist of the present invention. For example, the body of the scanner 10 does not need to be L-shaped, but may be of any proper shape. Instead of being connected to the head portion 2, the upper end 5b of the guard member 5 may be connected to the grip portion 1. Therefore, the scope of the present invention is solely intended to be defined by the accompanying claims.

1. A handheld scanner comprising:
a body,
a trigger provided on said body, and
a trigger guard member having a first end and a second end, at least one of said two ends being connected to said body and extending from said body such that said trigger is located between said body and said guard member so as to prevent said trigger from accidental or inadvertent activation.

2. The handheld scanner of claim 1, wherein both of said ends of said trigger guard member are connected to said body, forming a loop with said body surrounding said trigger.

3. The handheld scanner of claim 1, wherein said body comprising a grip portion adapted to be held by a user, and said trigger is provided on said grip portion.

4. The handheld scanner of claim 3, wherein said body further comprising a scanner head portion assuming an angle with said grip portion.

5. The handheld scanner of claim 4, wherein said first end of said trigger guard member is connected to said grip portion, and said second end of said trigger guard member is connected to said scanner head portion.

6. The handheld scanner of claim 5, wherein said trigger is located approximate to said first end of said trigger guard member.

7. The handheld scanner of claim 5, wherein said second end is connected to said scanner head portion at a location approximate to a front end of said scanner head portion.

8. The handheld scanner of claim 1, wherein said at least one end of said trigger guard member is detachably connected to said body.

9. The handheld scanner of claim 8, wherein said at least one end of said trigger guard member is connected to said body by one or more fasteners.

10. The handheld scanner of claim 9, wherein said fasteners comprise one or more screws or bolts.

11. The handheld scanner of claim 1, further comprising an antenna for wireless communications, wherein said antenna is mounted on said trigger guard member.

12. The handheld scanner of claim 11, wherein said wireless communications comprises communications by a RF signal for a RFID scanning.

13. A handheld scanner, comprising a body forming a scanner head portion and a grip portion, a trigger for activating a scan operation provided on said grip portion, and a trigger guard forming a loop with said body surrounding said trigger, thereby preventing accidental or inadvertent activation of said trigger.

14. The handheld scanner of claim 13, wherein said body has a generally L-shaped profile, and said grip portion forms one leg, while said scanner head portion forms the other leg.

15. The handheld scanner of claim 14, wherein said trigger guard is an elongate member having a first end and a second end, and both of said ends are connected to said body.

16. The handheld scanner of claim 15, wherein said two ends of said trigger guard are detachably connected to said body.

17. The handheld scanner of claim 16, wherein said first end of said trigger guard is connected to said grip portion, and said second end of said trigger guard is connected to said scanner head portion.

18. The handheld scanner of claim 17, wherein said first end of said trigger guard is close to said trigger, and said second end is close to a free front end of said scanner head portion.

19. The handheld scanner of claim 13, further comprising an antenna for wireless communications, wherein said antenna is installed in said trigger guard.

20. The handheld scanner of claim 19, wherein said wireless communications comprises communications by a RF signal for a RFID scanning.
